(19) United States
(12) Patent Application Publication
(10) Pub. No.: US 2017/0217115 A1
(43) Pub. Date: Aug. 3, 2017

(54) HOT-MOLDING METHOD USING PLASTIC ELASTOMER TO FABRICATE VAMP

(71) Applicant: KUO-LANG PAN, Taoyuan (TW)

(72) Inventor: KUO-LANG PAN, Taoyuan (TW)

(21) Appl. No.: 15/177,838

(22) Filed: Jun. 9, 2016

(30) Foreign Application Priority Data
Jan. 29, 2016 (CN) 201610063812.X

(51) Int. Cl. B29D 35/12

(52) U.S. Cl. CPC B29D 35/126; B29D 35/128; B29K 2995/007; B29K 2995/0021; B29K 2021/003

(57) ABSTRACT

A hot-molding method using a plastic elastomer to fabricate a vamp comprises steps: fabricating a hot-molding mold according to a pattern design of a vamp; fabricating blanks of different thicknesses, shapes, sizes, colors and materials; placing the blanks in the hot-molding mold; placing the hot-molding mold in a hot-molding machine to undertake a hot-molding process; and taking the hot-molding mold out of the hot-molding machine and then taking out the vamp from the mold after cooling. The method enables a single vamp to simultaneously use blanks of different thicknesses, shapes, colors and materials and diversifies vamp designs. The method fixes blanks securely in the mold and joins blanks of different colors to an identical vamp in a single process. The blanks are hard to peel off the vamp after molding. The method features a short fabrication cycle, high efficiency and high yield.

### FIELD OF THE INVENTION

The present invention relates to a hot-molding technology, particularly to a hot-molding method using a plastic elastomer to fabricate a vamp.

### BACKGROUND OF THE INVENTION

Thermoplastic Elastomer (TPE) is a rubber-like material featuring high elasticity, high strength, high resilience, and injection-moldability. TPE is environment-friendly and non-toxic. Further, TPE has superior coloring capability, weatherabilty, fatigue resistance, temperature tolerance, workability, and soft touch. Furthermore, TPE is exempt from sulfurization and can be recycled for remolding. TPE can be molded singly or stuck to/coated on a matrix material, such as PP, PE, PC, PS, or ABS.

TPE has the following advantages: 1. TPE molding is exempted from any special fabrication equipment and can be realized with an ordinary thermoplastic molding machine; 2. As sulfurization for TPE is very fast and can be directly undertaken in the injection machine, the efficiency of fabricating TPE products is very high; 3. TPE can be easily recycled; the residual material, unqualified products, abandoned products of TPE can be directly recycled as renewable resources to decrease fabrication cost and reduce environmental pollution; 4. As TPE is free from sulfurization or sulfurized for a very short period of time in fabricating TPE products, fabrication of TPE products is energy-efficient; 5. TPE simultaneously has the advantages of plastic and rubber, and thus has a wide application field; 6. TPE can enhance the strength and toughness of plastic with a simple formula whose adverse effect on polymer is slight and whose effect on quality and performance of polymer is easy to control.

However, the current technology usually fills the liquid mixture of a polyester polyol and triisocaynate into a mold, evacuates the mold, heats the mold to form a vamp, and cools down the mold before demolding. While mixed, the polyester polyol and triisocaynate does not react completely. In such a case, the product of the incompletely-ripened mixture is not an environmental-protection material, likely to crack and raise the discarding rate. Although the cracks are hard to observe from appearance, the products are easy to fracture during usage. Thus, the quality is degraded. The current technology can generate single-color products. Further, the requirement for a cooling process prolongs the fabrication cycle (8-10 hours) and increases the fabrication cost. Furthermore, the products have a limited hardness range and a high discarding rate (about 5-15%).

TPU denotes thermoplastic polyurethanes. TPU mainly includes the polyester-based group and the polyether-based group. TPU has a wide hardness range (60HA-85HD), oil resistance, transparency, and good elasticity. TPU is extensively used in the fields of daily commodities, sports products, toys, decorative materials, etc. TPU is halogen-free and flame-retardant, able to replace soft PVC to satisfy the environmental-protection demand appearing in more and more fields.

TPU has the following main characteristics: wide harness range: TPU products can have different hardness via varying the proportions of the reactant components, and the products still have superior elasticity and wear resistance with the increased hardness; high mechanical strength: TPU products have outstanding bearing capacity, impact resistance, and damping capacity; superior cold resistance: TPU has a lower glass transition temperature and still possesses fine elasticity, compliance and other physical properties at a temperature as low as −35° C.; good workability: TPU products can be fabricated in the ordinary technologies used by the thermoplastic materials, such as the injection-molding technology, the extrusion technology and the rolling technology. Further, TPU can be processed together with some polymers to form polymer alloys, which share the properties thereof and have oil resistance, water resistance, and fungus resistance. Further, TPU products can be easily recycled for regeneration.

The current 3D printing technology usually forms an ink net on a mesh fabric or artificial leather and then dries the composite layers. However, each composite layer merely has a thickness of less than 1.0 mm. After each printing process, the composite layer must be dried. The dryness of the composite layers influences the quality of the printed patterns. Further, the organic solvent used by the technology impairs health of operators. Furthermore, the current technology cannot generate relief patterns but can only print planar ones. Besides, the current technology has a longer fabrication cycle (4 hours for operation and 24 hours for drying).

### SUMMARY OF THE INVENTION

The primary objective of the present invention is to provide a hot-molding method using a plastic elastomer to fabricate a vamp, whereby to overcome the problems of the conventional technologies.

To achieve the abovementioned objective, the present invention proposes a hot-molding method using a plastic elastomer to fabricate a vamp, which comprises steps:

Step 1: fabricating a hot-molding mold according to a pattern design of a vamp;

Step 2: respectively using different specifications of polymeric materials to fabricate blanks having different thicknesses, shapes, sizes and colors according to the pattern design of the vamp, wherein the sizes of the blanks match the hot-molding mold;

Step 3: respectively placing the blanks in corresponding positions of the hot-molding mold, covering a vamp material (mesh fabric) over the blanks, and closing the hot-molding mold;

Step 4: placing the hot-molding mold in a hot-molding machine to undertake a hot-molding process at a temperature of 90-150° C. under a pressure of 20-55 kg/cm² for 1-5 minutes; and

Step 5: taking the hot-molding mold and the vamp thereinside out of the hot-molding machine, cooling the hot-molding mold and the vamp thereinside to secure the shape of the vamp, and then opening the hot-molding mold to take out the vamp.

In a preferred embodiment, the blanks are made of materials having an identical hardness or materials having two or more different hardnesses in Step 2.

In a preferred embodiment, the blanks are made of materials having an identical color or materials having two or more different colors in Step 2

In a preferred embodiment, positioning holes are formed in the hot-molding mold.

In a preferred embodiment, color-separation grooves are formed in the hot-molding mold.

The hot-molding method of the present invention enables a single vamp to simultaneously use blanks of different thicknesses, shapes, colors and materials and thus diversifies vamp designs. For example, an identical vamp has regions of different hardnesses. The hot-molding method of the present invention fixes blanks securely in the mold and joins different blanks to an identical vamp in a single process. Via the present invention, the blanks are hard to peel off the vamp after molding. The hot-molding method of the present invention features a short fabrication cycle, high efficiency and high yield. After molding, the blanks still keep the wear resistance, bendability, tear resistance, and ductility. Therefore, the present invention is adapted to different shoe designs and able to fabricate different types of sports shoes. The color-separation groves in the mold of the present invention can prevent mutual interference between neighboring blanks. The positioning holes in the mold of the present invention can enhance the precision of mold alignment. The cooling process after molding secures the shape of the vamp, favors demolding, and avoids deformation of the vamp.

### BRIEF DESCRIPTION OF THE DRAWINGS

FIG. 1 is a diagram schematically showing the structure of blanks according to one embodiment of the present invention;

FIG. 2 is a diagram schematically showing the structure of a mold according to one embodiment of the present invention; and

FIG. 3 is a diagram schematically showing the assemblage of a mold and blanks according to one embodiment of the present invention.

### DETAILED DESCRIPTION OF THE PREFERRED EMBODIMENTS

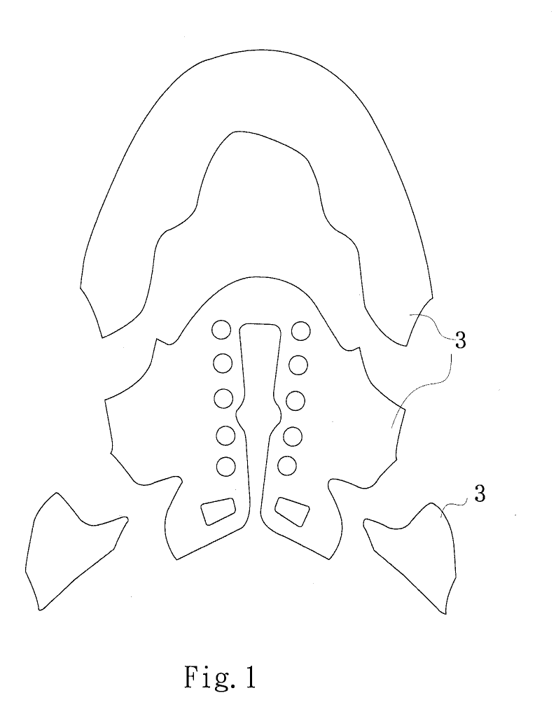

Below, embodiments and drawings are used to demonstrate the present invention in detail. Refer to FIGS. 1-3. In one embodiment, the present invention proposes a hot-molding method using a plastic elastomer to fabricate a vamp, which comprises Steps 1-5.

In Step 1, fabricate a hot-molding mold 1. The hot-molding mold 1 normally has recessed structures. The hot-molding mold 1 includes a plurality of blank basins 2 where the blanks 3 are placed and fixed.

In Step 2, respectively use different specifications of polymeric materials to fabricate blanks 3 having different thicknesses, shapes, sizes and colors according to the requirements of the vamp patterns. Normally, the zones adjacent to each other, having an identical color and made of an identical material are fabricated jointly to form an independent blank 3. The finished blanks 3 are assembled to the hot-molding mold 1. The sizes of the blanks 3 should match blank basins 2 of the hot-molding mold 1.

In Step 3, respectively place the blanks 3 in the corresponding blank basins 2, cover a vamp material over the blanks 3, and close the hot-molding mold 1. The vamp material is usually a mesh fabric.

In Step 4, place the hot-molding mold 1 in a hot-molding machine to undertake a hot-molding process at a temperature of 90-150° C. under a pressure of 20-55 kg/cm² for 1-5 minutes.

In Step 5, take the hot-molding mold 1 and the vamp thereinside out of the hot-molding machine, cool the hot-molding mold 1 and the vamp thereinside to secure the shape of the vamp, and then open the hot-molding mold 1 to take out the vamp.

In practical application, the temperature, pressure and processing time in Step 4 can be modified according to the hardness and thickness of the materials.

Refer to FIG. 1. In order to obtain different colors and functions in Step 2, the blanks 3 are made of materials having an identical hardness or materials having two or more different hardnesses; the blanks 3 are made of materials having an identical color or materials having two or more different colors. If the blanks 3 are made of an identical material and having an identical color, the identical material is fabricated to have the desired thickness and color and then cut to have the desired shapes. Therefore, the blanks 3 made of an identical material and having an identical color can be fabricated in a lower cost.

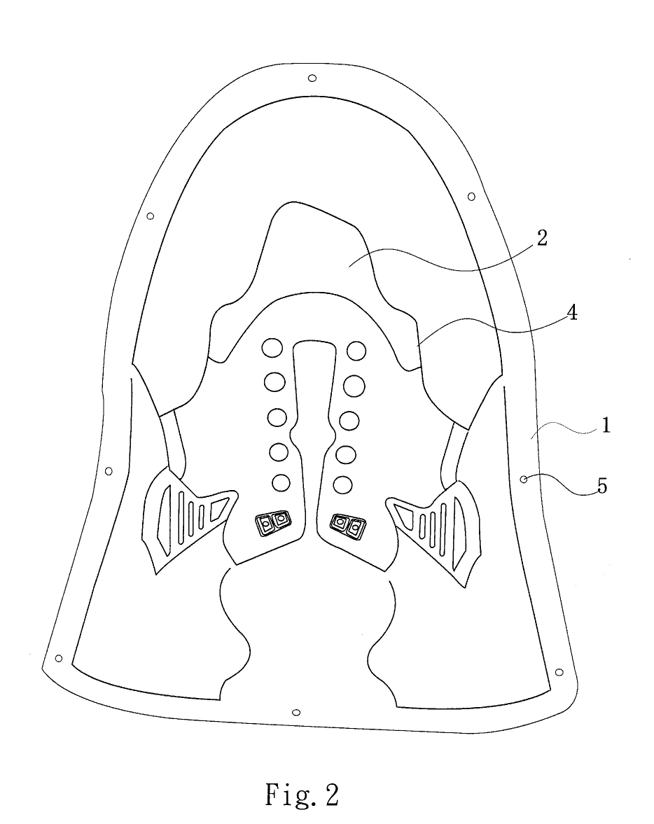

Refer to FIG. 2. Positioning holes 5 are formed in the hot-molding mold 1 to position the hot-molding mold 1 and prevent the hot-molding mold 1 from sliding during the hot-molding process lest the blanks 3 cannot be stuck to the vamp accurately.

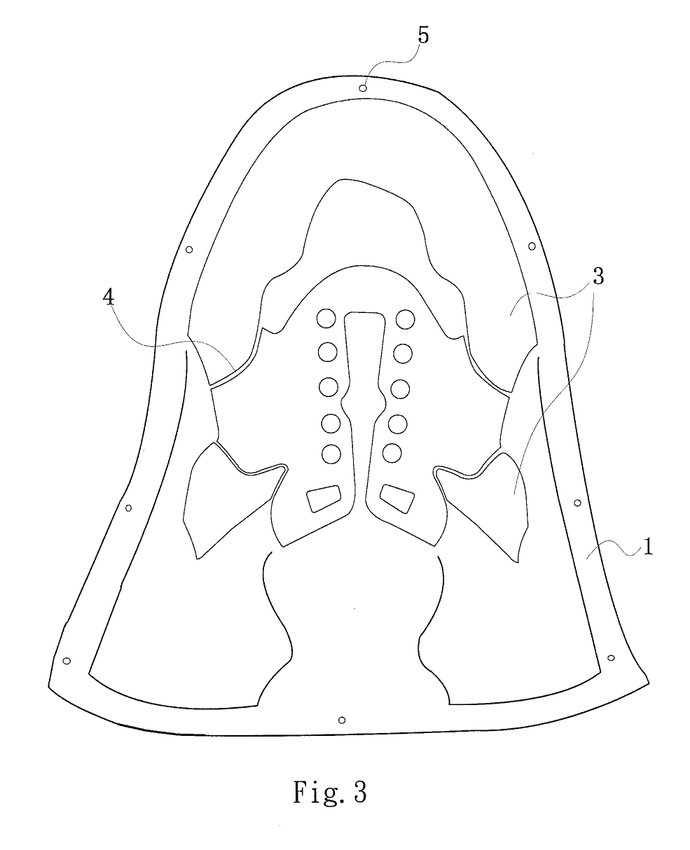

Refer to FIG. 2 and FIG. 3. In order to decrease the mutual interference between neighboring blanks 3, the hot-molding mold 1 includes color-separation grooves 4 between blanks 3 respectively using different materials or having different colors. The color-separation grooves 4 of the hot-molding mold 1 can form narrow convex structures in the vamp to separate neighboring blanks 3 lest they overlap during the hot-molding process. The surfaces of the color-separation grooves 4 of the hot-molding mold 1 are electroplated to prevent from stickiness during the hot-molding process.

In order to acquire the optimized theimal adhesion effect of blanks from the hot-molding process, the polymeric material normally adopts TPE or TPU, wherein TPE denotes thermoplastic elastomer materials and TPU denotes thermoplastic polyurethane materials. TPE and TPU have appropriate hardness and thermoplasticity and can be formulated to obtain materials having different hardnesses and different toughnesses. Therefore, TPE and TPU are suitable materials for blanks of vamps.

What is claimed is:

1. A hot-molding method using plastic elastomer to fabricate vamp, characterized in comprising the steps of:
Step 1: fabricating a hot-molding mold according to a pattern design of a vamp;
Step 2: respectively using different specifications of polymeric materials to fabricate blanks having different thicknesses, shapes, sizes and colors according to the pattern design of the vamp, wherein the sizes of the blanks match the hot-molding mold;
Step 3: respectively placing the blanks in corresponding positions of the hot-molding mold, covering a vamp material over the blanks, and closing the hot-molding mold;
Step 4: placing the hot-molding mold in a hot-molding machine to undertake a hot-molding process at a temperature of 90-150° C. under a pressure of 20-55 kg/cm² for 1-5 minutes; and
Step 5: taking the hot-molding mold and a vamp thereinside out of the hot-molding machine, cooling the hot-molding mold and the vamp thereinside to secure the shape of the vamp, and then opening the hot-molding mold to take out the vamp.

2. The hot-molding method using plastic elastomer to fabricate vamp according to claim 1, characterized in
that the blanks are made of materials having an identical hardness or materials having two or more different hardnesses in Step 2.

3. The hot-molding method using plastic elastomer to fabricate vamp according to claim 1, characterized in
that the blanks are made of materials having an identical color or materials having two or more different colors in Step 2.

4. The hot-molding method using plastic elastomer to fabricate vamp according to claim 1, characterized in
that positioning holes are formed in the hot-molding mold.

5. The hot-molding method using plastic elastomer to fabricate vamp according to claim 1, characterized in
that color-separation grooves are formed in the hot-molding mold.
